(19) United States
(12) Patent Application Publication
(10) Pub. No.: US 2007/0177229 A1
(43) Pub. Date: Aug. 2, 2007

(54) Imaging device calibration system and method

(76) Inventors: Gianni Cessel, Barcelona (ES); Celio Sanz Martinez, Barcelona (ES)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/342,521

(22) Filed: Jan. 30, 2006

(51) Int. Cl. H04N 1/46

(52) U.S. Cl. 358/504; 358/406

(57) ABSTRACT

An imaging device calibration system comprises a controller configured to cause at least one of a plurality of calibration strips to be extended into an exposed position relative to an optical module of the imaging device.

### BACKGROUND OF THE INVENTION

Imaging devices, such as scanners, copiers, printers, facsimile machines, and multi-function devices, capture and/or generate an image of an object using an array of photosensitive elements. However, because of manufacturer non-uniformity, dust or contaminants, or other causes, response characteristics from pixel-to-pixel and/or between different arrays of photosensitive elements may be different. Thus, calibration techniques are used to compensate for such variations. For example, one calibration process includes sampling imaging pixels of the photosensitive elements in response to scanning a target of known characteristics and calculating gain and offset values. However, such calibration processes are generally time-consuming and, for some devices, require scanning of multiple targets.

### BRIEF DESCRIPTION OF THE DRAWINGS

For a more complete understanding of the present invention and the advantages thereof, reference is now made to the following descriptions taken in connection with the accompanying drawings in which:

FIGS. 1A and 1B are diagrams illustrating an embodiment of an imaging device calibration system in accordance with the present invention; and

FIG. 2 is a block diagram of an imaging device employing an embodiment of a calibration system to advantage in accordance with the present invention.

### DETAILED DESCRIPTION OF THE DRAWINGS

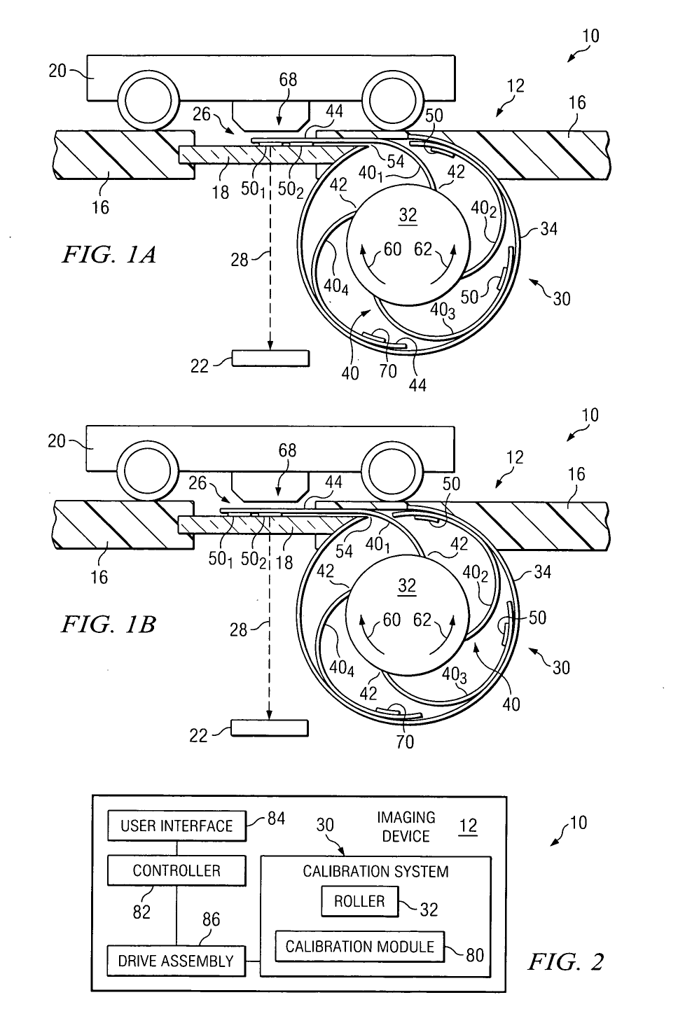

The preferred embodiments of the present invention and the advantages thereof are best understood by referring to FIGS. 1A-2 of the drawings, like numerals being used for like and corresponding parts of the various drawings.

FIGS. 1A and 1B are diagrams illustrating an embodiment of a calibration system 10 for an imaging device 12 in accordance with the present invention. Imaging device 12 may comprise any type of device for generating an image of an object such as, but not limited to, a scanner, copier, printer, facsimile device, or multi-function device. In the embodiment illustrated in FIGS. 1A and 1B, imaging device 12 comprises a housing 16, a platen 18 for supporting thereagainst an object to be imaged or scanned, an automatic document feeder (ADF) 20 for automatically feeding objects to be imaged or scanned toward and away from platen 18, and an optical module 22 for receiving light reflected by and/through a particular object for generating an image thereof. Optical module 22 may comprise one or more types of photosensitive elements such as, but not limited to, an array of charge-coupled devices (CCDs), one or more contact image sensors (CISs), or other types of photosensitive elements.

In the embodiment illustrated in FIGS. 1A and 1B, ADF 20 is configured to automatically feed objects to a scan window 26 of imaging device 12 through which the object is viewable by or exposed to optical module 22. In the embodiment illustrated in FIGS. 1A and 1B, objects are fed past scan window 26 for imaging thereof while optical module 22 remains in a substantially stationary position. However, it should be understood that imaging device 12 may be otherwise configured (e.g., additionally, or alternatively, a movable optical module 22 relative to a stationary object). Thus, in operation, light reflected by, or transmitted through, an object to be imaged or scanned is received by optical module 22 along a scan line or path 28.

System 10 also comprises a calibration system 30 for calibrating optical module 22. In the embodiment illustrated in FIGS. 1A and 1B, calibration system 30 comprises a roller 32 rotatably disposed within a cylindrical housing 34. A plurality of flexible calibration strips 40 are coupled to roller 32 in a circumferentially spaced-apart pattern. In FIGS. 1A and 1B, four calibration strips 40₁, 40₂, 40₃, and 40₄ are illustrated as being coupled to roller 32. However, it should be understood that a greater or fewer quantity of calibration strips 40 may be used. Further, it should be understood that calibration strip(s) 40 may extend a full width or scanning dimension of platen 18 (e.g., as measured longitudinally along an axis of roller 32) or, additionally or alternatively, calibration strip(s) 40 may be disposed in a spaced-apart relationship along roller 32 (e.g., spaced apart longitudinally along roller 32 as measured in the direction of an axis of roller 32). In the embodiment illustrated in FIGS. 1A and 1B, each calibration strip 40 comprises an end 42 fixed or coupled to roller 32 (e.g., disposed within a slit formed in roller 32 and/or otherwise affixed to roller 32) and a free end 44. One or more calibration strips 40 comprise at least one calibration pattern 50 disposed thereon for providing different types of image patterns and/or colors for calibrating optical module 22. For example, in the embodiment illustrated in FIGS. 1A and 1B, calibration strips 40₂ and 40₃ each comprise a single calibration pattern 50, and calibration strip 40₁ comprises two calibration patterns 50₁ and 50₂. However, it should be understood that different quantities of calibration patterns 50 may be disposed on one or more calibration strips 40. Calibration patterns 50 may be disposed on or formed as part of a particular calibration strip 40 (e.g., imprinted on or formed as part of the calibration strip 40 or a separate element adhered to a particular calibration strip 40). However, it should be understood that calibration patterns 50 may be otherwise formed or coupled to calibration strips 40. In FIGS. 1A and 1B, the size of calibration patterns 50 is exaggerated for purposes of illustration and ease of understanding; it should be understood that calibration patterns 50 are preferably flush with calibration strips 40 or extend minimally away therefrom.

In the embodiment illustrated in FIGS. 1A and 1B, housing 34 is formed having a slit or opening 54 disposed therein to enable calibration strips 40 to extend therethrough from an internal area 56 of housing 34 toward scan window 26. For example, in operation, roller 32 is rotated in the direction indicated by 60 to position free end 44 of a desired or particular calibration strip 40 near opening 54. After positioning free end 44 of a particular calibration strip 40 near opening 54, roller 32 is rotated further in the direction indicated by 62 (e.g., opposite the direction indicated by 60) to extend free end 44 of the particular calibration strip 40 through opening 54 and translate free end 44 toward scan window 26. In the embodiment illustrated in FIGS. 1A and 1B, a portion 64 of housing 16 is disposed over and spaced apart from opening 54 to guide free end 44 of the particular calibration strip 40 toward scan window 16. Roller 32 is rotated in the direction indicated by 62 until calibration pattern 50 disposed on the particular calibration strip 40 is disposed in an exposed position, indicated generally by 68, relative to optical module 22 to facilitate scanning of calibration pattern 50 by imaging module 22.

Thus, in operation, rotation of roller 32 in the directions indicated by 60 and 62 enables calibration strips 40, and corresponding calibration patterns 50, to be automatically and alternatively exposed to optical module 22 for calibrating optical module 22. For example, after imaging an exposed calibration pattern 50 on a particular calibration strip 40, roller 32 is rotated in the direction indicated by 60 relative to housing 34 to retract the exposed calibration strip 40 from scan window 26 and draw the particular calibration strip 40 into internal area 56 of housing 34. Continued rotation of roller 32 in the direction 60 causes different calibration strips 40 (i.e., the free ends 44 thereof) to be positioned near opening 54 to facilitate selection and extension of another calibration strip 40 and corresponding calibration pattern 50 to scan window 26. Moreover, after imaging a particular calibration pattern 50, the corresponding calibration strip 40 is retracted from scan window 26, thereby facilitating selection of another calibration strip 40 and calibration pattern 50 for scanning or scanning of an object.

In some embodiments of the present invention, calibration system 30 is used to automatically and alternatively position different calibration patterns 50 disposed on a single calibration strip 40 to optical module 22 for calibrating optical module 22. For example, in the embodiment illustrated in FIGS. 1A and 1B, calibration strip 40₁ comprises two different calibration patterns 50₁ and 50₂ disposed in a spaced-apart relationship relative to each other on calibration strip 40₁. Referring to FIG. 1A, roller 32 is illustrated as having been rotated in the direction 62 until calibration pattern 50₁ is located in exposed position 68 for imaging of calibration pattern 50₁ by optical module 22. Referring to FIG. 1B, rotation of roller 32 relative to housing 34 an additional amount in the direction indicated by 62 causes movement of calibration strip 40₁ relative to scan window 25 to facilitate positioning of calibration pattern 50₂ at exposed position 68 for imaging thereof by optical module 22. Thus, in operation, embodiments of the present invention enable different calibration patterns 50 disposed on a single calibration strip 40 to be interchangeably and/or independently exposed and/or positioned relative to optical module 22 for calibration of optical module 22, thereby facilitating a more efficient and flexible calibration process. After scanning or imaging calibration patterns 50₁ and/or 50₂, rotation of roller in the direction 60 is used to retract calibration strip 40₁ from scan window 26.

In some embodiments of the present invention, at least one calibration strip 40 is configured having a cleaning element coupled thereto or disposed thereon for cleaning platen 18 at least in the area of scan window 26. For example, in the embodiment illustrated in FIGS. 1A and 1B, calibration strip 40₄ comprises a cleaning element 70 coupled thereto such that, in response to selection and extension of calibration strip 40₄ by rotating roller 32 in the directions indicated by 60 and 62 as described above, cleaning element 70 is moved across at least a portion of scan window 26 to clean platen 18 (e.g., removing dust or other types of particulate matter). In FIGS. 1A and 1B, the size of cleaning element 70 is exaggerated for purposes of illustration and ease of understanding; it should be understood that size of cleaning element 70 may be varied.

Therefore, embodiments of the present invention enable different calibration strips 40 and corresponding calibration patterns 50 to be alternately exposed to imaging module 22 for calibrating imaging module 22 without user intervention (e.g., without having the user physically replace and position multiple objects having different calibration patterns thereon for calibrating imaging module 22). Additionally, embodiments of the present invention enable different calibration patterns 50 on a single calibration strip 40 to be alternately exposed to imaging module 22 for calibrating imaging module 22 and/or a calibration strip 40 having a cleaning element 70 extended across scan window 26 to clean platen 18.

FIG. 2 is a block diagram illustrating an embodiment of calibration system 10 for imaging device 12 in accordance with the present invention. In the embodiment illustrated in FIG. 2, imaging device 12 comprises a calibration module 80, a controller 82, a user interface 84, and a drive assembly 86. Calibration module 80 and/or controller 82 may comprise hardware, software, or a combination of hardware and software. Calibration module 80 is used to calibrate optical module 22 using image information generated by imaging one or more calibration patterns 50 (FIGS. 1A and 1B). Controller 82 is used to control operation of calibration system 30 to position particular calibration patterns 50 in exposed position 68 relative to optical module 22 (FIGS. 1A and 1B). For example, in the embodiment illustrated in FIG. 2, imaging device 12 comprises a drive assembly 86 coupled to roller 32 of calibration system 30 for imparting rotational movement of roller 32 relative to housing 34 in the directions indicated by 60 and 62 (FIGS. 1A and 1B). Drive assembly 86 may comprise a motor or other type of device for causing rotational movement of roller 32.

In operation, calibration module 80 interfaces with controller 82 to perform a calibration process for optical module 22. The calibration process may be initiated according to a predetermined schedule, after a predetermined quantity of scanning operations, or otherwise. Calibration module 80 interfaces with controller 82 to cause a particular calibration strip 40 and, correspondingly, a particular calibration pattern 50, to be positioned in exposed position 68 relative to optical module 22. Controller 82 causes actuation of drive assembly 86 to impart rotational movement to roller 32 in the directions indicated by 60 and/or 62 to extend and/or retract calibration strips 40 relative to scan window 26. Each calibration strip 40 may be alternately extended and retracted relative to scan window 26 in a particular sequence (e.g., 40₄ (to clean platen 18), followed by 40₁, then 40₂, and then 40₃), particular calibration strips 40 may be extended and retracted based on a particular calibration need (e.g., only calibration strip 40₂ based on the type of calibration pattern 50 disposed thereon), or otherwise. However, it should be understood that other sequences or selection criteria may be used. Further, it should be understood that extension and retraction of calibration strip 40 having cleaning element 70 may be performed independently of a calibration process (e.g., in response to a user request, in response to detection of dust or debris in scan window 26 and/or according to a predetermined schedule).

In some embodiments of the present invention, the calibration process may also be initiated and/or controlled by a user of imaging device 12 via user interface 84. For example, user interface 84 may comprise a display element, keyboard, mouse, or other type of device for inputting and/or outputting information relative to imaging device 12. In some embodiments of the present invention, a user may initiate a calibration process via user interface 84 to alternately image one or more calibration patterns 50 for calibrating optical module 22. Additionally, or alternatively, a user may request that a particular calibration pattern 50 be disposed in the exposed position 68 for performing a particular type of calibration process on optical module 22. Accordingly, in response to a particular request received from the user, calibration module 80 interfaces with controller 82 to cause actuation of drive assembly 86, thereby imparting rotational movement of roller 32 in the directions indicated by 60 and 62 to position a particular calibration pattern 50 in exposed position 68 and, after imaging thereof, retract the particular calibration strip 40 to a position within housing 34.

Thus, embodiments of the present invention provide an automatic and efficient calibration system and method for calibrating an imaging module of an imaging device by enabling different calibration patterns, located either on different calibration strips 40 or the same calibration strip 40, to be exposed to the imaging module. Thus, embodiments of the present invention facilitate a more efficient calibration process for calibrating the imaging module.

What is claimed is:

1. An imaging device calibration system, comprising:
a controller configured to cause at least one of a plurality of calibration strips to be extended into an exposed position relative to an optical module of the imaging device.

2. The system of claim 1, further comprising a roller having the plurality of calibration strips coupled thereto.

3. The system of claim 1, wherein at least one of the plurality of calibration strips comprises at least two different calibration patterns.

4. The system of claim 1, wherein the controller is configured to cause rotation of a roller to extend different ones of the plurality of calibration strips to the exposed position.

5. The system of claim 1, wherein the controller is configured to control rotation of a roller to alternately extend the plurality of calibration strips from within a housing to the exposed position.

6. The system of claim 1, wherein the plurality of calibration strips are disposed within a cylindrical housing.

7. The system of claim 6, wherein the controller is configured to cause at least one of the plurality of calibration strips to extend through an opening of the housing into the exposed position.

8. The system of claim 1, wherein at least one of the plurality of calibration strips comprises a cleaning element.

9. An imaging device calibration system, comprising:
at least one calibration strip having at least two different calibration patterns disposed thereon; and
a controller configured to cause movement of the at least one calibration strip to expose at least one of the at least two different calibration patterns to an optical module of the imaging device.

10. The system of claim 9, wherein the controller is configured to control rotation of a roller to cause movement of the at least one calibration strip to an exposed position relative to the optical module.

11. The system of claim 9, wherein the controller is configured to cause movement of the at least one calibration strip from a first position to a second position to independently expose the at least two different calibration patterns to the optical module.

12. The system of claim 9, wherein the at least one calibration strip is disposed within a cylinder.

13. The system of claim 12, wherein the controller is configured to cause the at least one free end of the at least one calibration strip to extend through an opening in the cylinder toward an exposed position relative to the optical module.

14. An imaging device calibration system, comprising:
means for automatically extending at least one of a plurality of calibration strips into an exposed position relative to an optical means of the imaging device.

15. The system of claim 14, further comprising means for imparting rotational movement to a roller to cause movement of the plurality of calibration strips relative to the optical means.

16. The system of claim 14, further comprising means for alternately exposing at least two different calibration patterns disposed on at least one of the plurality of calibration strips to the optical means.

17. The system of claim 14, further comprising means for extending a cleaning means disposed on at least one calibration strip across the exposed position.

18. An imaging device calibration method, comprising:
automatically extending at least one of a plurality of calibration strips to an exposed position relative to an optical module.

19. The method of claim 18, further comprising rotating a roller to alternately extend the plurality of calibration strips to the exposed position.

20. The method of claim 18, further comprising moving at least one of the plurality of calibration strips from a first position to a second position to expose at least a second different calibration pattern disposed on the at least one calibration strip to the optical module.

21. The method of claim 18, further comprising rotating a roller in a predetermined direction to position a free end of at least one of the plurality of calibration strips for extension toward a scan window of the imaging device.

22. The method of claim 21, further comprising rotating the roller in a direction opposite the predetermined direction to extend the free end of the at least one calibration strip toward the scan window.

23. The method of claim 18, further comprising extending a cleaning element across a platen relative to the exposed position.

24. The method of claim 18, further comprising extending at least one calibration strip having a cleaning element disposed thereon across a platen relative to the exposed position.
